(19) United States
(12) Patent Application Publication
(10) Pub. No.: US 2008/0101421 A1
(43) Pub. Date: May 1, 2008

(54) FAST AUDIO AND ANGLE SWITCHING VIA MULTIPLE DEMUX BUFFERS

(76) Inventors: Stephen Gordon, Lexington, MA (US); Steven Ross, Bedford, NH (US)

Correspondence Address: MCANDREWS HELD & MALLOY, LTD, 500 WEST MADISON STREET, SUITE 3400, CHICAGO, IL, 60661, US

(21) Appl. No.: 11/926,978

(22) Filed: Oct. 29, 2007

Related U.S. Application Data
(60) Provisional application No. 60/863,495, filed on Oct. 30, 2006.

(51) Int. Cl. H04J 3/04

(52) U.S. Cl. 370/535

(57) ABSTRACT

Presented herein are system(s) and method(s) for fast audio and angle switching via multiple demux buffers. In one embodiment, there is presented a circuit for decoding data. The circuit comprises a processor, a system clock, a plurality of queues, and at least one decoder. The processor demultiplexes a plurality of elementary streams from a multiplexed stream, wherein each of the plurality of elementary streams include portions, wherein each of the portions include time stamps. The system clock maintains a clock reference. The plurality of FIFOs correspond to the plurality of elementary streams and FIFO each of the plurality of elementary streams, wherein each of the plurality of FIFOs include a front end, and wherein the front end of each of the plurality of FIFOs stores the portion of the corresponding FIFO that includes a time stamp that is proximate to the clock reference. The at least one decoder decodes selected ones of the plurality of elementary streams by decoding portions at the front end of the FIFO corresponding to the selected ones of the plurality of elementary streams and a newly selected one of the plurality of elementary streams by switching from decoding portions at the front end of a FIFO corresponding to one of the selected ones of the plurality of elementary streams to decoding portions at the front end of a FIFO corresponding to the newly selected one of the plurality of elementary streams.

### RELATED APPLICATIONS

This application is related to “Method and System for Switching Elementary Streams on a Decoder with Zero Delay”, U.S. application Ser. No. 11/736,989, filed Apr. 18, 2007 by Ross, claiming priority to Provisional U.S. Application for Patent Ser. No. 60/863,495, filed Oct. 30, 2006, by Ross. Each of the foregoing applications are incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Various programs allow viewers to view the program with a variety of different options. Among the different options include language selection, subtitle language selection, viewing vantage selection, and choice of commentary to name a few.

The different options are provided by means of different elementary streams. A program can have a number of different elementary streams, where each elementary stream can provide, for example, an audio, a video, or a data selection.

Generally, a DVD movie or program is typically viewed with the simultaneous playing of audio and video selections, and in some cases, a data selection as well. In some cases, a user can decide to switch a particular selection, while leaving the other selections playing. Switching the particular selection can result in a delay on the order of ½ second or more from when the switching begins when the player begins outputting the new data from the switched decoder.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

The present invention is directed to system(s), method(s), and apparatus for fast audio and angle switching via multiple demux buffers, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram describing the presentation of data streams in accordance with an embodiment of the present invention;

FIG. 2 is a flow diagram for presenting data streams in accordance with an embodiment of the present invention;

FIG. 3 is a block diagram of an exemplary decoder in accordance with an embodiment of the present invention;

FIG. 4 is a block diagram of an exemplary decoder in accordance with an embodiment of the present invention; and

FIG. 5 is a flow diagram for presenting data streams in accordance with an embodiment of the present invention.

### DETAILED DESCRIPTION OF THE INVENTION

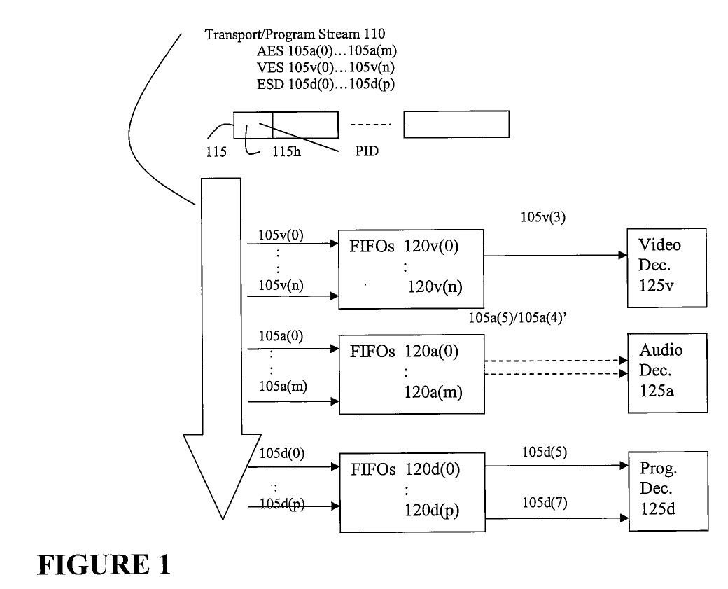

Referring now to FIG. 1, there is illustrated a block diagram describing the presentation of data streams in accordance with an embodiment of the present invention. A program can be associated with any number of video elementary streams 105v(0) . . . 105v(m), audio elementary streams 105a(0) . . . 105a(n), and elementary data streams 105d(0) . . . 105d(p).

In an exemplary program, each video elementary stream 105v can provide, for example, video from a particular vantage point. Each audio elementary stream 105a can provide audio in different languages. Each elementary data stream 105d can provide sub-titles in different languages.

Generally, the presentation of the program involves the simultaneous display of at least one video elementary stream 105v, at least one audio elementary stream 105a, and any number of different elementary streams of data 105d. Additionally, video elementary streams 105v, audio elementary streams 105a and elementary streams of data 105d are associated with a time base. The elementary streams 105 include time stamps that indicate the time for presentation of particular portions of the data. The time stamps can be compared to a local clock to synchronize the audio and video elementary streams 105 as well as any elementary streams of data 105d.

Each of the elementary streams 105 are provided in a multiplexed stream 110. A multiplexed stream can include, for example, a transport stream or a program stream. A transport stream is primarily used for transmission over a lossy medium, such as the internet, while a program stream is primarily used for transmission over a local medium, such as a bus. The multiplexed stream 110 comprises a plurality of packets 115. The packets 115 comprise data from a particular one of the elementary streams 105 and headers 115h. The headers 115h include packet identifier fields PID identifying the particular elementary stream. The term “packets” shall be understood to include program stream packs.

Each of the elementary streams 105 are demultiplexed from the multiplexed stream 110 based on the PIDs of the packets. FIFOs associated with each of the video streams 120v(0) . . . 120v(m), audio stream 120a(0) . . . 120a(n), and data streams 120d(0) . . . 120d(p), store a recent portion of each of the streams associated therewith.

Selected ones of the video elementary stream(s) 105v(0) . . . 105v(m), audio elementary stream(s) 105a(0) . . . 105a(n), and elementary data stream(s) 105d(0) . . . 105d(p) can be presented, such as by a screen, speaker or other output device. The selected streams are decoded by video decoder(s) 125v, audio decoder(s) 125a, and program decoder(s) 125p. A decoder 125 decoding a particular elementary stream receives the elementary stream from the associated queue.

A system clock maintains local time. The head end of the FIFOs stores the portions of the elementary stream that are proximate to the local time. The decoders 125 decode the portion of the elementary stream that is in the head end of the queue. As the local time passes the time stamps associated with the portions of the elementary streams that are not selected, the FIFOs discard the portions. In certain embodiments of the present invention, the FIFOs can be implemented as circular buffers with certain predetermined depths.

A selected elementary stream 105 can be changed. For example, an audio elementary stream 105a(4) can be changed to audio elementary stream 105a(5), while continuing presentation of video elementary stream 105v(3) and elementary streams of data 105d(5) and 105d(7).

When the selected elementary stream 105 is changed, e.g., from audio elementary stream 105a(4) to elementary stream 105a(5), the audio decoder 125a switches from receiving the data from the FIFO storing audio elementary stream 105(4) to the FIFO storing audio elementary stream 105(5). This transition occurs seamlessly with respect to playing video elementary stream 105v(3) and elementary streams of data 105d(5) and 105d(7).

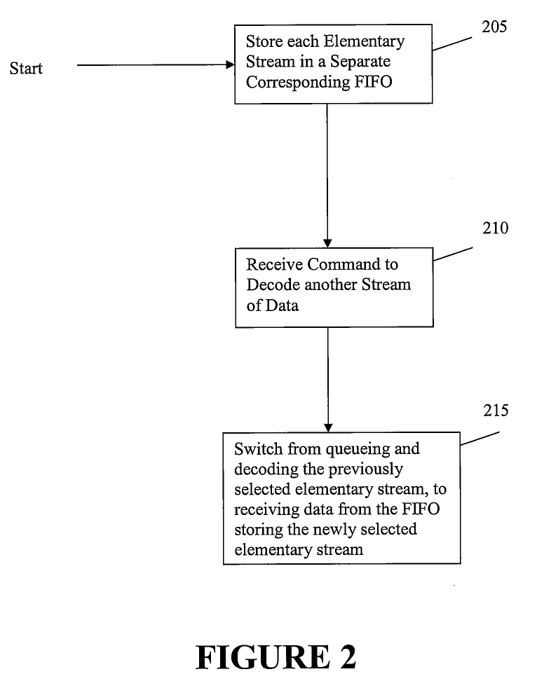

Referring now to FIG. 2, there is illustrated a flow diagram describing the presentation of data in accordance with an embodiment of the present invention. At 205, each elementary stream is queued in a separate and corresponding queue. At 210, a command is received to decode another stream of data, for example audio elementary stream 105a(5), instead of the current stream of data, e.g., audio elementary stream 105a(4).

After receiving the command, the decoder decoding the decoder decoding the previously selected elementary stream, elementary stream 105a(4) switches to receiving data from the FIFO storing the newly selected elementary stream, e.g., audio elementary stream 105a(5) at 215. The foregoing can be used for rapid transitioning from one media stream to another media stream during a multimedia presentation. In certain embodiments of the present invention, the transition from one media stream to another media stream can be seamless with respect to the continuous presentation of other media. For example, during the presentation of a movie, including the presentation of video and audio, the audio stream can be switched to another audio stream, such for example the audio in another language, in a manner that is seamless with respect to the video and appears relatively continuous to the viewer.

In certain embodiments, the streams of data can include data that is compressed in accordance with a variety of data compression standards. For example, the Motion Pictures Experts Group (MPEG) has promulgated a number of different standards for video data compression, such as MPEG-2, and Advanced Video Compression (AVC), and audio compression, MPEG-1 and MP3. Certain embodiments of the present invention can be used with streams of data that include audio and video data that is compressed in accordance with the foregoing standards.

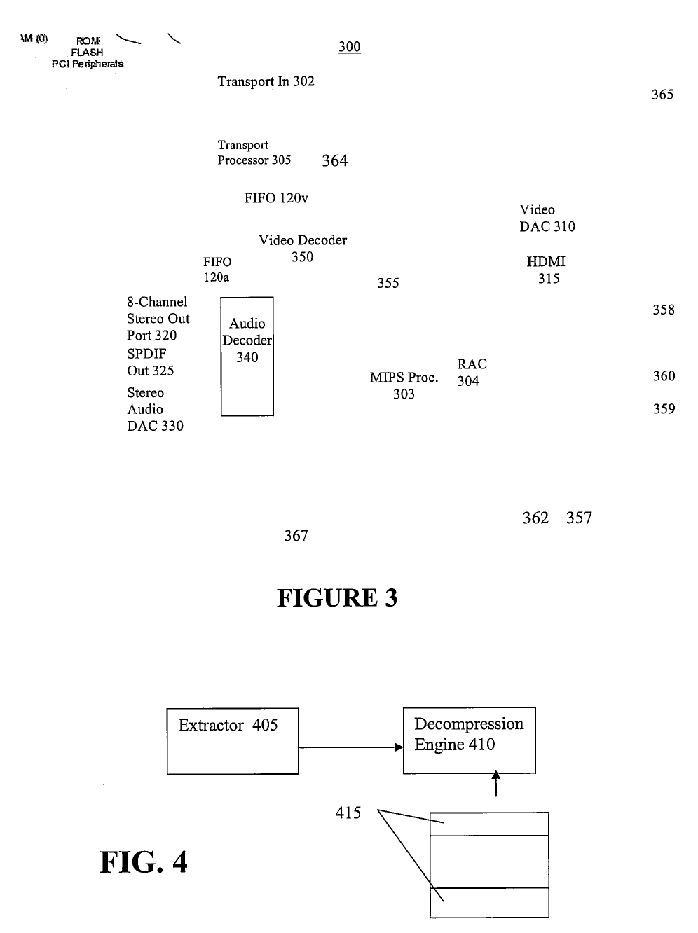

Referring now to FIG. 3, there is illustrated a block diagram of an exemplary DVD integrated circuit 300 in accordance with an embodiment of the present invention. The integrated circuit 300 can provided a highly integrated silicon platform for High Definition DVD players. It may be also be used in conjunction with a separate encoder.

The integrated circuit 300 receives a multiplexed stream 110 at input 302 that carries a plurality of elementary streams 105, and presents the data from selected elementary streams 105 for presentation. The video data from the selected video elementary stream(s) can be output in Component Video, or S-Video via video digital to analog converter (DAC) 310, and HDMI via HDMI output port 315. The analog data from the selected analog elementary stream(s) can be output in 7.1 Channel Output format or Stereo I2S format via 8 Channel/Stereo output port 320, SPDIF format from SPDIF output port 325, and analog via Stereo Audio Digital Audio Converter 330.

The integrated circuit 300 can include a core processor 303, such as, for example, a 4350 dual-thread MIPS processor supporting HD-DVD and BD graphics, HD-DVD and BD Navigation, interconnectivity, content protection and decryption, and a floating point unit for graphics (font rendering) and JAVA support. The core processor can include a multimedia unit, 32K/16K instruction, 32K data cache, and a 128K read ahead cache (RAC) 304 for performance.

The integrated circuit 300 can include a multiplexed stream processor 305 for receiving a multiplexed stream 110. As noted above, the multiplexed stream 110 comprises a plurality of packets 115 carrying from particular elementary streams 105 and headers 115h. The headers 115h include packet identifier fields PID identifying the particular elementary stream.

The multiplexed stream processor 305 receives a multiplexed stream via input 302 and demultiplexes each of the elementary streams 105. The multiplexed stream 110 includes multiplexed packets 115 with PIDs identifying different elementary streams. The multiplexed stream processor 305 parses the multiplexed packet 115 headers 115h, examining the PIDs to demultiplex the audio elementary streams and video elementary streams. The multiplexed stream processor 305 provides each demultiplexed audio elementary streams 105a to audio FIFOs 120a, and the demultiplexed video elementary streams 105v to video FIFOs 120v.

Audio decoder(s) 340 decodes audio elementary streams 105a that are selected for presentation, while video decoder 350 decodes video elementary streams 105v that are selected for presentation. Selected ones of the video elementary stream(s) 105v(0) . . . 105v(m), audio elementary stream(s) 105a(0) . . . 105a(n), can be presented, such as by a screen, speaker or other output device. A system clock maintains local time. The head end of the FIFOs 120 stores the portions of the elementary stream which are proximate to the local time. The audio decoder(s) 340 and video decoder(s) 350 decode the portion of the elementary stream that is in the head end of the queue. As the local time passes the time stamps associated with the portions of the elementary streams that are not selected, the FIFOs discard the portions. In certain embodiments of the present invention, the FIFOs can be implemented as circular buffers with certain predetermined depths.

A selected elementary stream 105 can be changed. For example, an audio elementary stream 105a(4) can be changed to audio elementary stream 105a(5), while continuing presentation of video elementary stream 105v(3) and elementary streams of data 105d(5) and 105d(7).

When the selected elementary stream 105 is changed, e.g., from audio elementary stream 105a(4) to elementary stream 105a(5), the audio decoder 340 decoding audio elementary stream 105a(4) switches to decoding audio elementary stream 105a(5).

In certain embodiments of the present invention, the change of elementary streams can be responsive to receipt of a command to switch received at port 364.

Video Decoder

The video decoder 350 decodes video elementary streams provided by selected one(s) of the video FIFOs 120v. The video decoder 350 can transition from one selected video elementary stream to another. Responsive thereto, the video decoder 350 changes the codec associated with the previously selected video elementary stream to a codec associated with the newly selected video elementary stream. In certain embodiments, the switching of the selected video elementary stream can cause an interrupt. The interrupt can cause the video decoder 350 to switch to the appropriate codec and queue.

The video decoder 350 can be equipped with codecs to decode video data compressed in accordance with Advanced Video Coding (AVC, also known as H.264, and MPEG-4, Part 10), SMPTE VC-1 Advanced Profile Level 3, SMPTE VC-1 Simple Profile to Medium Level, and SMPTE VC-1 Main Profile to High Level. The video decoder 350 can be capable of simultaneous single high definition and standard definition decoding.

The video decoder 350 provides decoded and decompressed video to a video and graphics processor 355. In certain embodiments, the video and graphics processor 355 can provide any of the following features:
Hardware support for two content and user interaction-driven 2D graphics planes with full HD resolution—Presentation Graphics Plane
Foreground (Interactive) Graphics Plane
Vendor OSD graphics overlay plane (in addition to the two planes described above), overlays all graphics and video planes)
Alpha-blending capabilities on all planes
Simultaneous support for HD and SD output of the same content and graphics
Select between overlay plane only or scaled version of composite output for secondary outputs
Video Scaler: Horizontal and vertical with programmable zooming (frame by frame); independently configured for each video stream
Alpha blending capabilities

### Three levels of graphics, two video

### HD-DVD Clear Rect Function on secondary video plane

Motion adaptive de-interlacer
Thomson Film Grain insertion technology (FGT)
Main Output Compositor with five inputs

### Three graphics feeds and two video feeds

Component outputs can output a reduced resolution version of the full HD signal if the corresponding AACS—defined flag is set by the content provider (DVO and HDMI outputs must remain at full resolution).

A single output image is then sent to the VEC (video encoder) which converts it to the various analog and digital output formats (composite video, S-video, RF video, component video, HDMI, DVI, etc).

### Audio Decoder

The audio decoder 340 receives and decodes selected audio elementary stream(s) 105a from selected one(s) of the audio FIFOs 120a and provides the decoded audio data to the 8 Channel/Stereo output port 320, SPDIF output port 325, and Stereo Audio Digital Audio Converter 330.

The audio decoder 340 can transition from one selected audio elementary stream to another by changing from receiving data from one audio FIFO 120a to another audio FIFO 120a. Responsive thereto, the audio decoder 340 changes the codec associated with the previously selected audio elementary stream to a codec associated with the newly selected audio elementary stream. In certain embodiments, the change of the selected audio elementary stream can cause an interrupt. The interrupt can cause the audio decoder 340 to switch to the appropriate codec.

The audio decoder 340 can include any of the following features:

Audio Standards
LPCM to 7.1 channels
MPEG audio
MPEG-1 Layer III (MP3) to stereo
Dolby Digital (AC3) to 5.1 channels
Dolby Digital Plus to 7.1 channels
Dolby TrueHD MLP (Compressed LPCM)—DTS to 5.1 channels DTS—HD to 7.1 channels
MPEG-4 High-Efficiency AAC to 5.1 channels WMA Pro LPCM
MLP (Compressed LPCM) aka Dolby TrueHD—AAC-HE (IP-STB)
Dolby Digital multi-channel Bass Management support, with equivalent support for DTS
PCM audio mixing and post processing—Primary and Secondary decoded streams with:
   Audio clips input over Host I/F or from stream input
   Individually controlled mixing and fading
Speaker Management Capabilities; minimum support for “Small,” “Large,” and “Off” settings
PCM audio mixing and post-processing
   Mix primary and secondary decoded streams with effects sounds (PCM)
   Individually controlled mixing and fading
Re-encode result of mixed primary and secondary programs and PCM effects for S/PDIF or HDMI output:
   Formats: AC-3 5.1, DTS 5.1

The integrated circuit 300 can include a number of system interfaces, including, for example, Dual SATA interfaces 357, Parallel IDE interface 358, 10/100 Base T Ethernet Port 359, Dual USB 2.0 host ports 360, 32-bit PCI v2.2 33-MHz Master/Target interface/EBI Parallel Bus 362, Dual UART interface/GPIO/User interface pins 364, Serial Controller (SC) ports 365, NAND flash support, external FLASH support. The integrated circuit 300 can also include a number of different memory interfaces, such as DDR Interfaces 367, and SDRAM controllers.

In certain embodiments of the present invention, the integrated circuit can consume 7.0 W in full operation (simultaneous HD and SD decoding, dual audio programs, and full graphics package running). The integrated circuit 300 can also include a power down mode that reduces the power consumption from the active state by a minimum of 90% or the level required by phase 2 of the EnergyStar specification for DVD devices (<1 Watt). In the foregoing state, the processor and user interface remain active. The supply voltage for the core may be 1.2V, the DDR interface 367 supply voltage may be 1.8V, and the PCI/EBI/GPIO interface 362 voltage may be 3V. The integrated circuit 300 can also include a voltage regulator that provides 2.5V from a 3.3V input and outputs it on a power pin for use on the integrated circuit 2.5 inputs.

In one embodiment of the present invention can comprise a chip with each of the aforementioned structures integrated thereon, and further comprising a plurality of pins that are electrically connected to the various input and output ports thereby providing access to external structures.

In certain embodiments of the present invention, the integrated circuit 300 can provide selected ones of the audio elementary streams 105a and video elementary streams 105v for display. At least one selected ones of the audio elementary streams 105a and the video elementary streams 105v can be changed while the remaining ones of the selected audio elementary streams 105a and the video elementary streams 105v are seamlessly provided for presentation.

Referring now to FIG. 4, there is illustrated a block diagram describing an exemplary decoder 305 in accordance with an embodiment of the present invention. The decoder comprises an extractor 405, a decompression engine 410, and a plurality of codecs 415. In certain embodiments of the present invention, decoder 305 could comprise a video decoder 350, wherein the decompression engine 410 comprises a video decompression engine and the plurality of codecs 415 comprise video codecs. In certain embodiments of the present invention, decoder 305 could comprise a audio decoder 340, wherein the audio decompression engine 410 comprises an audio decompression engine and the plurality of codecs 415 comprise audio codecs.

The decompression engine 410 loads a codec associated with a selected elementary stream and decodes data provided by the FIFO 120. When the elementary stream changes, the extractor 405 generates an interrupt to the decompression engine 410. The interrupt causes the decompression engine 410 to change the codec 415 to the codec associated with the newly selected elementary stream.

In certain embodiments of the present invention, a marker from the FIFO 120 causes the extractor 405 to generate an interrupt to the decompression engine 410. In other embodiments, the extractor 405 can detect the change in the elementary stream and interrupt the decompression engine 410.

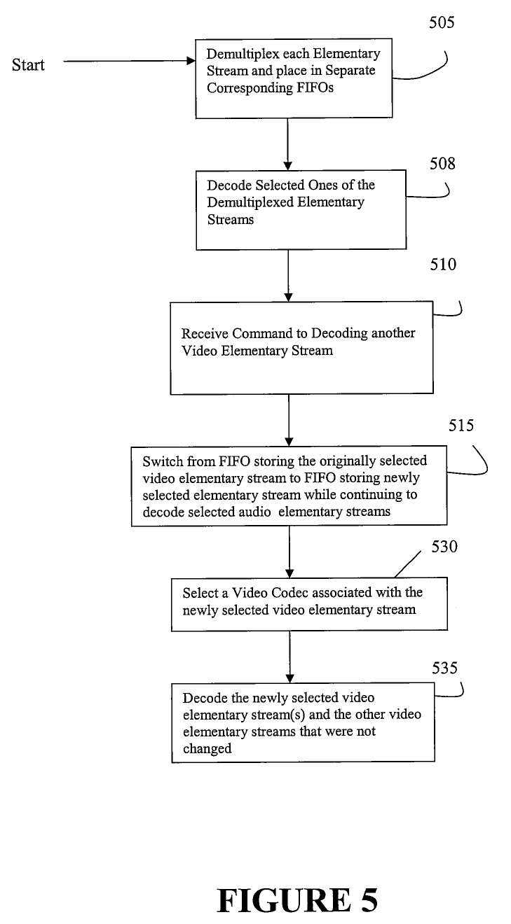

Referring now to FIG. 5, there is illustrated a flow diagram for presenting multimedia data in accordance with an embodiment of the present invention. At 505, multiplexed stream processor 305 demultiplexes each of the audio elementary streams and video elementary stream and places the demultiplexed elementary streams in respective audio FIFOs 120a and video FIFOs 120v. At 508, the video decoder(s) 350 and audio decoder(s) 340 decode selected one(s) of the demultiplexed elementary streams. At 510, a command is received by the video decoder 350 via port 364 to decode another video elementary stream(s) of data associated with the same program, instead of the current at least one video elementary stream. At 515, the video decoder(s) 350 switch from the FIFO storing the selected video elementary stream(s) during 508, to the new video elementary stream(s) indicated during 510. The audio decoder 340 continues to decode the audio elementary streams while the video decoder 350 continues to decode other video elementary stream(s) that were not changed during 510.

At 530, the video decompression engine 410 selects a video codec associated with the newly selected video elementary stream(s). At 535, the video decoder 350 decodes the newly selected video elementary stream(s), the other video elementary stream(s) that were not changed during 510, while the audio decoder 340 decodes the audio elementary stream(s).

The embodiments described herein may be implemented as a board level product, as a single chip, application specific integrated circuit (ASIC), or with varying levels of the decoder system integrated with other portions of the system as separate components.

The degree of integration of the decoder system may primarily be determined by the speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on VC-1, H.264, and MPEG-2 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A circuit for decoding data, said circuit comprising:
a processor for demultiplexing a plurality of elementary streams from a multiplexed stream, wherein each of the plurality of elementary streams comprises portions, wherein each of the portions comprises time stamps;
a system clock for maintaining a clock reference;
a plurality of FIFOs corresponding to the plurality of elementary streams for queuing each of the plurality of elementary streams, wherein each of the plurality of FIFOs comprise a front end, and wherein the front end of each of the plurality of FIFOs stores the portion of the corresponding FIFO that comprises a time stamp that is proximate to the clock reference; and
at least one decoder for decoding selected ones of the plurality of elementary streams by decoding portions at the front end of the FIFO corresponding to the selected ones of the plurality of elementary streams and a newly selected one of the plurality of elementary streams by switching from decoding portions at the front end of a FIFO corresponding to one of the selected ones of the plurality of elementary streams to decoding portions at the front end of a FIFO corresponding to the newly selected one of the plurality of elementary streams.

2. The circuit of claim 1, wherein the at least one decoder further comprises:
an extractor for receiving the selected ones of the elementary stream; and
a decompression engine for decompressing selected ones of the elementary streams.

3. The circuit of claim 1, wherein plurality of elementary streams comprise audio elementary stream and a video elementary stream.

4. The circuit of claim 1, wherein the multiplexed stream comprises a transport stream.

5. The circuit of claim 1, wherein the multiplexed stream comprises a program stream.

6. The circuit of claim 1, wherein the at least one decoder further comprises:
a video decoder for decoding video data; and
an audio decoder for decoding audio data.

7. An integrated circuit for decoding data, said integrated circuit comprising:
a transport processor for receiving a transport stream, said transport stream comprising a plurality of packets, each of the packets comprising a portion of one of a plurality video elementary streams and a plurality of audio elementary streams, an identifier identifying the one of the plurality video elementary streams and a plurality of audio elementary streams, and a time stamp, wherein said transport processor demultiplexes each of the plurality of video elementary streams and the plurality of audio elementary streams by demultiplexing the portions of the video elementary streams and the audio elementary streams;
a system clock for maintaining a clock reference;
a plurality of audio FIFOs corresponding to the plurality of audio elementary streams for queuing each of the plurality of audio elementary streams, wherein each of the plurality of audio FIFOs comprise a front end, and wherein the front end of each of the plurality of audio FIFOs stores the portion of the corresponding FIFO that comprises a time stamp that is proximate to the clock reference; and
a plurality of video FIFOs corresponding to the plurality of video elementary streams for queuing each of the plurality of video elementary streams, wherein each of the plurality of video FIFOs comprise a front end, and wherein the front end of each of the plurality of video FIFOs stores the portion of the corresponding FIFO that comprises a time stamp that is proximate to the clock reference.

8. The integrated circuit of claim 7, further comprising:
at least one audio decoder for decoding selected ones of the plurality of audio elementary streams by decoding portions at the front end of audio FIFOs corresponding to the selected ones of the plurality of elementary streams and a newly selected one of the plurality of audio elementary streams by switching from decoding portions at the front end of an audio FIFO corresponding to one of the selected ones of the plurality of audio elementary streams to decoding portions at the front end of an audio FIFO corresponding to the newly selected one of the plurality of audio elementary streams.

9. The integrated circuit of claim 8, wherein the at least one video decoder further comprises:
an extractor for receiving the selected ones of the video elementary stream; and
a video decompression engine for decompressing selected ones of the video elementary streams.

10. The integrated circuit of claim 7, further comprising:
at least one video decoder for decoding selected ones of the plurality of video elementary streams by decoding portions at the front end of video FIFOs corresponding to the selected ones of the plurality of video elementary streams and a newly selected one of the plurality of video elementary streams by switching from decoding portions at the front end of an video FIFO corresponding to one of the selected ones of the plurality of video elementary streams to decoding portions at the front end of an video FIFO corresponding to the newly selected one of the plurality of video elementary streams.

11. The integrated circuit of claim 10, wherein the at least one video decoder further comprises:
an extractor for receiving the selected ones of the video elementary stream; and
a video decompression engine for decompressing selected ones of the elementary streams.

12. A method for decoding data, said method comprising:
receiving a program stream, said program stream comprising a plurality of packs, each of the packs comprising a portion of one of a plurality video elementary streams and a plurality of audio elementary streams, an identifier identifying the one of the plurality video elementary streams and a plurality of audio elementary streams, and a time stamp;
demultiplexing each of the plurality of video elementary streams and the plurality of audio elementary streams by demultiplexing the portions of the video elementary streams and the audio elementary streams;
maintaining a clock reference;
queuing each of the plurality of audio elementary streams in a plurality of audio FIFOs corresponding to the plurality of audio elementary streams, wherein each of the plurality of audio FIFOs comprise a front end, and wherein the front end of each of the plurality of audio FIFOs stores the portion of the corresponding FIFO that comprises a time stamp that is proximate to the clock reference;
queuing each of the plurality of video elementary streams in a plurality of video FIFOs corresponding to the plurality of video elementary streams, wherein each of the plurality of video FIFOs comprise a front end, and wherein the front end of each of the plurality of video FIFOs stores the portion of the corresponding FIFO that comprises a time stamp that is proximate to the clock reference.

13. The method of claim 12, further comprising:
decoding selected ones of the plurality of audio elementary streams by decoding portions at the front end of audio FIFOs corresponding to the selected ones of the plurality of audio elementary streams and a newly selected one of the plurality of audio elementary streams by switching from decoding portions at the front end of an audio FIFO corresponding to one of the selected ones of the plurality of audio elementary streams to decoding portions at the front end of a FIFO corresponding to the newly selected one of the plurality of audio elementary streams.

14. The method of claim 13, further comprising:
decoding selected ones of the plurality of video elementary streams by decoding portions at the front end of video FIFOs corresponding to the selected ones of the plurality of video elementary streams, while decoding the selected ones of the audio elementary streams and the newly selected audio elementary stream.

15. The method of claim 14, wherein decoding selected ones of the plurality of video elementary streams further comprises decompressing the selected ones of the plurality of video elementary streams.

16. The method of claim 14, wherein decoding selected ones of the plurality of audio elementary streams further comprises decompressing the selected ones of the plurality of audio elementary streams.

17. An integrated circuit for decoding data, said integrated circuit comprising:
a program processor for receiving a program stream, said program stream comprising a plurality of packs, each of the packs comprising a portion of one of a plurality video elementary streams and a plurality of audio elementary streams, an identifier identifying the one of the plurality video elementary streams and a plurality of audio elementary streams, and a time stamp, wherein said program processor demultiplexes each of the plurality of video elementary streams and the plurality of audio elementary streams by demultiplexing the portions of the video elementary streams and the audio elementary streams;
a system clock for maintaining a clock reference;
a plurality of audio FIFOs corresponding to the plurality of audio elementary streams for queuing each of the plurality of audio elementary streams, wherein each of the plurality of audio FIFOs comprise a front end, and wherein the front end of each of the plurality of audio FIFOs stores the portion of the corresponding FIFO that comprises a time stamp that is proximate to the clock reference; and
a plurality of video FIFOs corresponding to the plurality of video elementary streams for queuing each of the plurality of video elementary streams, wherein each of the plurality of video FIFOs comprise a front end, and wherein the front end of each of the plurality of video FIFOs stores the portion of the corresponding FIFO that comprises a time stamp that is proximate to the clock reference.

18. The integrated circuit of claim 17, further comprising:
at least one audio decoder for decoding selected ones of the plurality of audio elementary streams by decoding portions at the front end of audio FIFOs corresponding to the selected ones of the plurality of elementary streams and a newly selected one of the plurality of audio elementary streams by switching from decoding portions at the front end of an audio FIFO corresponding to one of the selected ones of the plurality of audio elementary streams to decoding portions at the front end of an audio FIFO corresponding to the newly selected one of the plurality of audio elementary streams.

19. The integrated circuit of claim 18, wherein the at least one video decoder further comprises:
an extractor for receiving the selected ones of the video elementary stream; and
a video decompression engine for decompressing selected ones of the video elementary streams.

20. The integrated circuit of claim 17, further comprising:
at least one video decoder for decoding selected ones of the plurality of video elementary streams by decoding portions at the front end of video FIFOs corresponding to the selected ones of the plurality of video elementary streams and a newly selected one of the plurality of video elementary streams by switching from decoding portions at the front end of an video FIFO corresponding to one of the selected ones of the plurality of video elementary streams to decoding portions at the front end of an video FIFO corresponding to the newly selected one of the plurality of video elementary streams.

21. The integrated circuit of claim 20, wherein the at least one video decoder further comprises:
an extractor for receiving the selected ones of the video elementary stream; and
a video decompression engine for decompressing selected ones of the elementary streams.
